(19) United States
(12) Patent Application Publication
(10) Pub. No.: US 2005/0089343 A1
(43) Pub. Date: Apr. 28, 2005

(54) Heat sinking fuser rolls to reduce thermal transients

(75) Inventor: James E. Mathers, Rochester, NY (US)

Correspondence Address: Lawrence P. Kessler;Patent Legal Staff, Eastman Kodak Company, 343 State Street, Rochester, NY, 14650-2201, US

(73) Assignee: Eastman Kodak Company

(21) Appl. No.: 10/955,417

(22) Filed: Sep. 30, 2004

Related U.S. Application Data
(60) Provisional application No. 60/514,702, filed on Oct. 27, 2003.

(51) Int. Cl. G03G 15/20

(52) U.S. Cl. 399/69; 399/328

(57) ABSTRACT

A heat sink roller (34) is provided as part of a fuser apparatus (10) to reduce or eliminate thermal transients of a heated fuser roller (12). The fuser roller (12) is normally heated to its standby setpoint temperatures. Before the start of a copy run the heat sink roller (34) is moved to contact fuser roller (12), causing a temperature gradient due to thermal load placed on fuser roller (12). Once the run setpoint temperatures are reached, heat sink roller (34) is removed from contacting fuser roller (12), and receiver members (16) are passed through the fuser apparatus. When the last receiver member passes through reproduction apparatus, heat sink roller (34) moves to once again contact fuser roller (12) and return it to the standby setpoint temperatures.

### FIELD OF THE INVENTION

The present invention generally relates to reducing thermal variations during a copy run of a copying device and, more specifically, to heat sinking a fuser roll of a copying device to reduce thermal transients at the start and finish of the copy run.

### BACKGROUND OF THE INVENTION

A common problem with almost all internally heated roll fusers of a copying device is the inherent thermal transients that occur throughout a copy run. The major time dependent transient, called temperature droop, occurs at the beginning of the copy run when the fusing unit switches from a standby mode to producing prints at full process speed. The standby power drain of the fuser is typically only a few hundred watts but, depending on the process speed of the copier/printer, the running power usage may be from about 1000 to about 5000 Watts. With an internally heated fuser, a considerable amount of time may be required for the roller elements (the metal core with its external coating) to stabilize to new operating temperatures and thermal gradients. The amount of time required to return to thermal stability will be dependent on the lamp wattage vs. the thermal load of the paper at process speed as well as the amount of thermal mass of the roller elements.

Thermal transients, called overshoot, may also occur upon completion of the copy run. In this case, when the thermal load of the passing paper is removed, the fuser roll temperature may increase above the operating temperature, even though the fuser unit has switched back to a standby mode. A substantial amount of time may be required for the roller elements to stabilize to new standby temperatures and thermal gradients.

When these thermal variations are encountered, they will inherently cause variations in the fused copy attributes, such as image permanence and image gloss. The amount of image glass variation within a color machine can easily become unacceptable. It may take, for example, from about 40 to about 50 copies to regain a steady state running and/or standby temperature condition when the thermal load of the paper is added or removed. As a result, these first 40 to 50 copies may be considered waste. Additionally, at the end of a copy run, there may be a delay in starting the next run as the fuser roller returns to a stead state standby temperature.

U.S. Pat. No. 5,196,894, issued to Merle et al. (Merle) discloses heat sink within a copying apparatus. More specifically, Merle discloses a heat sink member that is maintained substantially below the glass transition temperature of the toner. The heat sink member is used to cool a receiving sheet that has passed through the fuser roll, rapidly cooling the receiving sheet until the toner image and any heat-softenable layer are below their glass transition temperatures (col. 4, lines 45-53). Merle, however, does not address the problem of temperature transients, especially those at the start and finish of a copy run.

U.S. Pat. No. 5,937,231, issued to Aslam et al. (Aslam) discloses the use of a heat sink roller to control fuser roller temperature droop. The heat sink roller is made of a material having a thermal mass to match the heat take out rate of the nominal fuser operating process (col. 3, lines 60-62). Before the copy process begins, the heat sink roller contacts the fuser roller, removing heat from the fuser roller similar to the heat, which would be removed by copies being fused. When the paper begins to move through the fuser, the heat sink roller is removed, thereby reducing temperature droop. The heat sink roller of Aslam, however, requires a cool down period between uses. For example, if a short run of copies is made, the heat sink roller may not have a chance to cool down to its starting point and, therefore, would not be capable of simulating the heat which be removed by copies being fused. Aslam requires the heat sink roller to be at a relatively uniform starting temperature at the start of each operation. Furthermore, while Aslam may, with the limitations discussed above, help reduce temperature droop, it does not address the problem of overshoot at the end of a copy run. Indeed, Aslam may actually be incapable of correcting overshoot, especially in short copy runs where the heat sink has not had a chance to return to its original ambient temperature.

As can be seen, there is a need for an improved heat sinking fuser roll that reduces thermal transients, including droop and overshoot, without requiring the operator to wait between copy runs.

### SUMMARY OF THE INVENTION

As will be discussed in more detail below, one method to avoid fuser thermal variations during the course of a copy run may be to provide a thermal load to the fuser roll surface just prior to a copy run and establish temperatures and thermal gradients within the fuser roll elements (core and coating) typical of the steady state values they will obtain within the copy run. This thermal load can then be removed as the first unfused copy enters the fuser. Thus, the fuser roll surface will not have any temperature variations during the copy run, resulting in each and every copy/print being fused to an identical level.

In one aspect of the present invention, a mechanism for controlling temperature transients in a heated fuser roller of a reproduction apparatus includes a heat sink roller movable between a first position and a second position, the first position being separated from the fuser roller and the second position being in contact with the fuser roller; and a coolant inside the heat sink roller, the coolant selected to provide a contact heat load on the fuser roller when the heat sink roller is in contact with the fuser roller, the contact heat load being similar to a receiver member heat load on the fuser roller that would otherwise occur when a receiver member is passed through the fuser roller and an image is fused thereupon.

In another aspect of the present invention, a mechanism for controlling temperature transients in a heated fuser roller of a reproduction apparatus includes a heat sink roller movable between a first position and a second position, the first position being separated from the fuser roller and the second position being in contact with the fuser roller; a coolant inside the heat sink roller, the coolant selected to provide a contact heat load on the fuser roller when the heat sink roller is in contact with the fuser roller, the contact heat load being similar to a receiver member heat load on the fuser roller that would otherwise occur when a receiver member is passed through the fuser roller and an image is fused thereupon; an input tube for flowing the coolant into the heat sink roller; and an output tube for flowing the coolant out from the heat sink roller; wherein the coolant is virgin water from a water supply; the virgin water is fed to the heat sink roller through the input tube; and the virgin water passes through the heat sink roller and passes through the output tube to a wastewater drain.

In yet another aspect of the present invention, a fuser, for a reproduction apparatus, for permanently fixing a marking particle image to a receiver member, the fuser includes a heated fuser roller operating at a setpoint temperature; a heat sink roller movable between a first position and a second position, the first position being separated from the fuser roller and the second position being in contact with the fuser roller; and a coolant inside the heat sink roller, the coolant selected to provide a contact heat load on the fuser roller when the heat sink roller is in contact with the fuser roller, the contact heat load being similar to a receiver member heat load on the fuser roller that would otherwise occur when a receiver member is passed through the fuser roller and an image is fused thereupon.

In a further aspect of the present invention, a reproduction apparatus for permanently fixing a marking particle image to a receiver member includes a heated fuser roller operating at a setpoint temperature; a heat sink roller movable between a first position and a second position, the first position being separated from the fuser roller and the second position being in contact with the fuser roller; and a coolant inside the heat sink roller, the coolant selected to provide a contact heat load on the fuser roller when the heat sink roller is in contact with the fuser roller, the contact heat load being similar to a receiver member heat load on the fuser roller that would otherwise occur when a receiver member is passed through the fuser roller and an image is fused thereupon.

In still a further aspect of the present invention, a method for reducing thermal transients in a heated fuser roller operating at a setpoint temperature includes providing a heat sink roller movable between a first position and a second position, the first position being separated from the fuser roller and the second position being in contact with the fuser roller; filling the heat sink roller with a coolant; moving the heat sink roller into the second position at the start of a copy run; allowing the fuser roller to reach the setpoint temperature; moving the heat sink roller to the first position; and passing at least one receiver member through the fuser roller to fuse an image thereupon.

The reduction of thermal transients according to present invention has several advantages over conventional copying methods. First, thermal transients that occur throughout the copy run, especially those at the beginning and the end of the copy run, may be reduced or eliminated. Further, heat sink recovery time between copy runs may be reduced or eliminated with the method and apparatus of the present invention. Moreover, the copy runs may be successfully run without waste copies at the beginning of the run due to variations in image permanence and image gloss because of fuser roll temperature transients.

These and other features, aspects and advantages of the present invention will become better understood with reference to the following drawings, description, and claims.

### BRIEF DESCRIPTION OF THE DRAWINGS

In the detailed description of the preferred embodiment of the invention presented below, reference is made to the accompanying drawings, in which:

FIG. 1 shows a schematic view of a fuser roll with a cooler roll according to an embodiment of the present invention;

FIG. 2 shows a schematic view of one embodiment of the heat sink of the present invention;

FIG. 3 shows a schematic view of another embodiment of the heat sink of the present invention;

FIG. 4 shows a schematic view of yet another embodiment of the heat sink of the present invention;

FIG. 5 shows a graph of temperature vs. time of the fuser roll core and surface during a copy run; and

FIG. 6 shows a graph of temperature vs. time of the fuser roll core and surface, as well as the cooler roll surface as a cooler roll contacts the fuser roll.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is defined by the appended claims.

Broadly, the present invention provides a fuser roll that includes a heat-sink in order to avoid temperature transients that occur during a copy run. A heat-sinking roller may be applied to the fuser roll, prior to the copy run, to mimic the thermal load of the paper during a copy run. The fuser roll can draw more power to maintain a proper surface temperature. Once the fuser roll surface reaches a steady state, the heat sink may be removed and the paper may be fed through the apparatus. Because the fuser roll can draw sufficient power to handle the thermal load of the paper (which, prior to the copy run, this thermal load was mimicked by the heat sink), thermal droop at the start of the copy run may be reduced or eliminated.

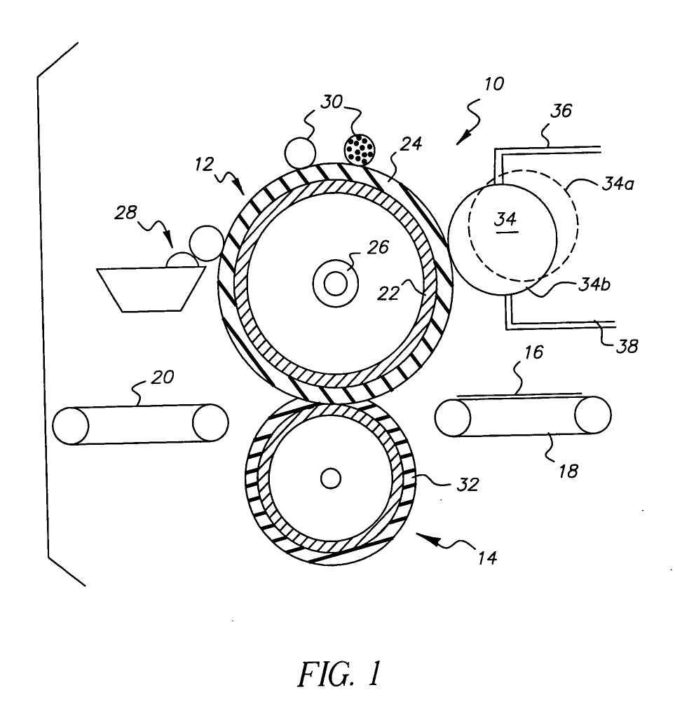

Referring to FIG. 1, there is shown a schematic drawing of a reproduction fuser apparatus 10 according to an embodiment of the present invention. Fuser apparatus 10 may include a fuser roller 12 in nip relation with a pressure roller 14. A receiver member 16, such as a sheet of paper, may be fed from a feeder belt 18, between the rotating fuser roller 12 and pressure roller 14, and out to a downstream transport belt 20.

Fuser roller 12 may include a core 22 and a fusing blanket 24 that is, for example, cylindrically shaped, and supported on core 22. Blanket 24 may be made of a rubber material particularly formulated to be heat conductive or heat insulative, depending on whether the fuser heat source is located within core 22 or in juxtaposition with the periphery of blanket 24. In the illustrated embodiment of the present invention, the heat source is an internal heater lamp 26. Therefore, blanket 24 may preferably be a heat conductive rubber material, allowing the surface temperature to quickly adjust to changes in heat output of heater lamp 26.

A conventional oiler mechanism 28 may selectively apply an oil to blanket 24 of fuser roller 12 to substantially prevent offsetting of the marking particle image to fuser roller 12. Additionally, a conventional cleaning mechanism 30 may wipe the surface of fuser roller 12 to remove excess offset preventing oil and other contaminants which could degrade the quality of the image fused to receiver member 16.

Pressure roller 14 may have an outer surface 32 that may form a pressurized nip with fuser roller 12. Pressure roller 14 may be made of metal, such as aluminum or steel, optionally coated with a suitable surface coating (not shown) to substantially prevent offsetting of the marking particle image to pressure roller 14. One example of a suitable surface coating may be Teflon.

A heat sink roller 34 can have a longitudinal axis substantially parallel with a longitudinal axis of fuser roller 12. The heat sink roller 34 may be moveably mounted between a first position (indicated by dotted line 34a in FIG. 1), where heat sink roller 34 is separated from fuser roller 12, and a second position (indicated by the solid line 34b in FIG. 1), where heat sink 34 contacts the surface of fuser roller 12, thereby placing a contact heat load on fuser roller 12. Heat sink roller 34 may preferably mimic the thermal capacity of the paper that would be passing through fuser roll 12 during a copy run. That is, heat sink roller 34 may remove substantially the same heat as a nominal image bearing receiver member 16 being fused at the nominal process speed and fusing setpoint temperature.

When the reproduction machine is in standby mode (that is, no reproduction request has been made), the surface fuser roller 12 may be heated to a predetermined standby setpoint temperature. To maintain this standby setpoint temperature, low energy output, for example, from about 300 to about 500 watts, is needed from internal heater lamp 26. In this state, the temperature at the core of fuser roller 12 will only be slightly above the standby setpoint temperature of the surface of fuser roller 12.

When a reproduction job is requested, heat sink roller 34 may be moved from its first position (not contacting fuser roller 12) to its second position (contacting the surface of fuser roller 12). On contact, heat sink roller 34 may create a contact heat load to immediately start to remove heat from fuser roller 12, thus simulating a receiver member heat load caused by heat being removed when copies are fused by fuser roller 12. This initial contact between heat sink roller 34 and fuser roller 12 may cause a surface temperature droop from the steady state standby setpoint temperature of fuser roller 12. To compensate for this temperature droop on the surface of fuser roller 12, internal heater lamp 26 may be supplied greater power, thereby causing the core of fuser roller 12 to increase. Therefore, a radial thermal gradient may be created in fuser roller 12 substantially equal to the radial thermal gradient, which would be created by copy fusing to sheets of paper. Heat sink roller 34 may remain in operative contact with fuser roller 12 until the surface temperature of fuser roller 12 returns at or near its steady state setpoint temperature. As an example, heat sink roller 34 can remain in operative contact with fuser roller 12 until the surface temperature of fuser roller 12 is within about 5 to about 20° F., and more preferably within about 3 to about 10° F., of its steady state temperature.

Once fuser roller 12 reaches its steady state temperature following contact with heat sink roller 34, the fuser roller 12 is ready to begin a copy run. When the first sheet of receiver member 16 is fed through fuser roller 12, heat sink roller 34 can return to its first position (not contacting fuser roller 12) and remain there until copy production run is complete. When the copy run is complete, heat sink roller 34 can return to its second position (contacting fuser roller 12), thereby eliminating overshoot that would otherwise result in the temperature of the surface of fuser roller climbing above the steady state temperature. The copy run may be considered complete when the last receiver member passes through fuser roller 12. Heat sink roller 34 may also return to its second position (contacting fuser roller 12) during a temporary error condition, such as being out of paper, out of ink, or the like, during a copy run. The application of heat sink roller 34 to fuser 12 during such an error condition may result internal heat lamp 26 providing output similar to that provided during the copy run. This may result in the surface temperature of fuser roller 12 remaining relatively constant, even after the copy job is resumed.

In one embodiment of the present invention, coolant, such as water, may flow through input tube 36, pass through heat sink roller 34, and out to waste through output tube 38. Coolant temperature, coolant flow rate, loading amount (nip width between fuser roller 12 and heat sink roller 34), and rotation speed of the rollers may be adjusted so that heat sink roller 34 mimics the thermal capacity of the paper that would run through fuser roll 12 during a copy run. For example, a heavy bond paper, having a higher thermal capacity, would require a heat sink roller 34 that would draw more energy from fuser roller 12, as compared to a lightweight paper.

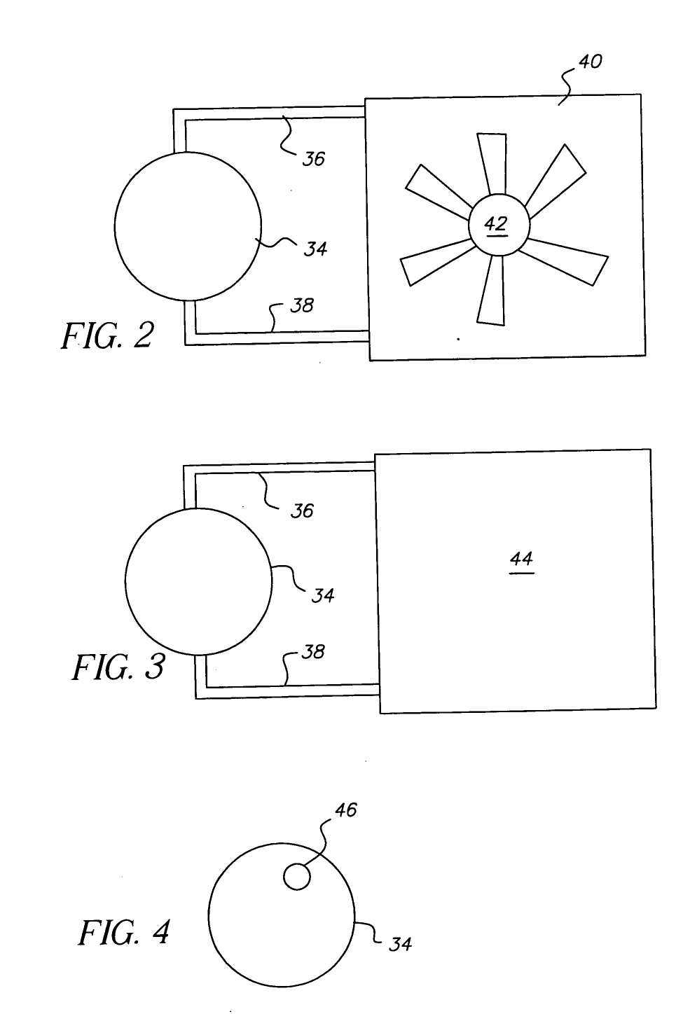

Referring to FIG. 2, there is shown an alternate embodiment of the heat sink roller 34 of the present invention. Instead of flowing virgin water through heat sink roller 34 and out to the waste as in the embodiment of FIG. 1, in this alternate embodiment of the present invention, coolant—such as water, ethylene glycol, silicon oil, or the like—may be circulated through a radiator 40 via input tube 36 and output tube 38. Radiator 40 may also include a fan 42 to help maintain the coolant at ambient temperature.

Referring to FIG. 3, there is shown yet another alternate embodiment of the heat sink roller 34 of the present invention. Instead of flowing virgin water through heat sink roller 34 and out to the waste as in the embodiment of FIG. 1, in this alternate embodiment of the present invention, coolant—such as water, ethylene glycol, silicon oil, or the like—may be circulated through a reservoir 44. Reservoir 44 may be a simple holding tank for storing the coolant. Reservoir 44 may be sized appropriately to cool heat sink roller 34 in an amount sufficient to mimic paper thermal load during operation while preventing significant heating of the coolant itself.

Referring to FIG. 4, there is shown still another alternate embodiment of the heat sink roller 34 of the present invention. Instead of flowing virgin water through heat sink roller 34 and out to the waste as in the embodiment of FIG. 1, in this alternate embodiment of the present invention, coolant—such as water, ethylene glycol, silicon oil, or the like—may be sealed within heat sink roller 34 via a cap 46. The internal volume of heat sink roller 34 and the coolant may be selected to cool heat sink roller 34 in an amount sufficient to mimic paper thermal load during operation while preventing significant heating of the coolant itself.

While the above embodiments and the Example below described heat sink roller 34 using a liquid coolant, such as water, the invention is not meant to be so limited. For example, a gaseous coolant, such as air, may be circulated through input tube 36, into heat sink roller 34, and out through output tube 38, as shown in FIG. 1. Air flow and temperature may be chosen such that application of heat sink roller 34 onto fuser roller 12 mimics a heat draw similar to the paper being fed through the copier/printer.

### EXAMPLES

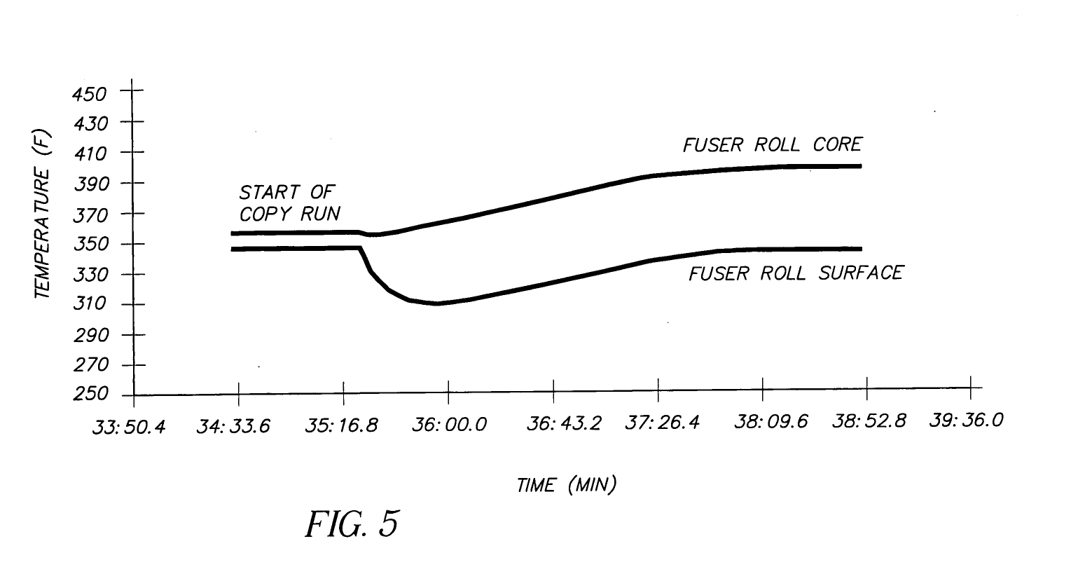

Referring to FIGS. 1 and 5, fuser roller 12, having an internal heating lamp 26 with a maximum output of about 3000-5000 W, was sitting in standby, at a constant steady state temperature as shown at time 34:00.0 in FIG. 5. In this state, fuser roller 12 had a small thermal gradient across blanket 24. Heat sink roller 34 was at its first position, not in contact with fuser roller 12. Receiver members 16 were then introduced between fuser roller 12 and pressure roller 14 at full process speed. The outer surface of fuser roller 12 initially experienced a very large droop downward, as can be seen at a time of about 36:00.0. After about two minutes, the surface of fuser roller 12 returned to a steady state temperature. The copies/prints made during this three-minute period may not be of acceptable quality due to image gloss variation.

The magnitude of the droop seen in FIG. 5 is mainly governed by the heat-give-up-ability (conductivity/diffusivity) of blanket 24 and the dwell time with the input media (receiver member 16). The power of internal heating lamp 26 has little to do with the magnitude of this variation. During the copy run, internal heating lamp 26 must not only supply energy to receiver member 16, but also supply additional energy to heat the roller elements (aluminum core 22 and elastomer blanket 24) such that the surface of fuser roller 12 returns to its steady state control point.

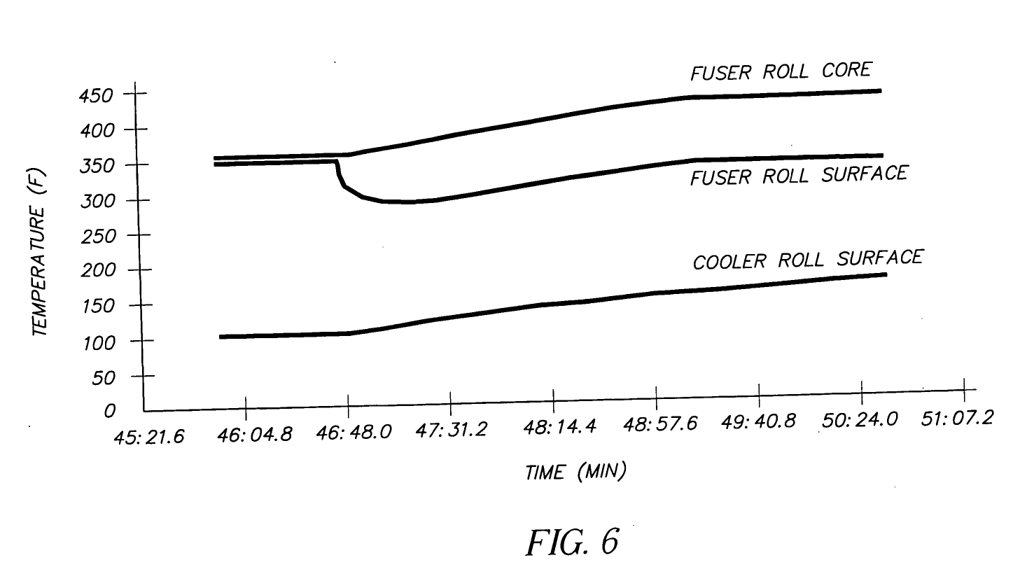

Referring now to FIGS. 1 and 6, the same fuser roller 12 used for the graph shown in FIG. 5, having an internal heating lamp 26 with a maximum output of about 3000-5000 W, was sitting in standby, at a constant steady state temperature as shown at time 46:04.8 in FIG. 6. In this state, fuser roller 12 had a small thermal gradient across blanket 24. Heat sink roller 34, filled with water similar to the embodiment shown in FIG. 4, was at its first position, not in contact with fuser roller 12. At approximately time 46:30.0, heat sink roller 34 was moved from its first position to its second position, making contact with fuser roller 12. The outer surface of fuser roller 12 initially experienced a very large droop downward, as can be seen at a time of about 46:48.0. After about three minutes, the surface of fuser roller 12 returned to a steady state temperature. At this point in time, receiver members 16 may now be fed through fuser roller 12 while heat sink roller 34 returns to its first position, not contacting fuser roller 12. The paper now being fed through fuser roller 12 may cause little or no temperature droop, thereby resulting in each and every copy being of the same copy quality and image gloss.

As shown in the graph of FIG. 6, the surface temperature of heat sink roller 34 increases slightly during the time that heat sink roller 34 is in contact with fuser roller 12. It is desirable to minimize this temperature rise within heat sink roller 34, thereby reducing the amount of time necessary for heat sink roller 34 to return to its original state between copy runs. One approach to minimizing this temperature rise is to use a coolant with a higher heat capacity, such as mineral oil or silicon oil, and/or to use a larger volume of coolant. Another approach to minimizing this temperature is to use a flowing coolant, as described above, and as described in the embodiments of FIGS. 1 through 3.

It should be understood, of course, that the foregoing relates to preferred embodiments of the invention and that modifications may be made without departing from the spirit and scope of the invention as set forth in the following claims.

### Parts List

10 fuser apparatus
12 fuser roller
14 pressure roller
16 receiver member
18 feeder belt
20 receiver belt
22 core
24 blanket
26 internal heater lamp
28 oiler mechanism
30 cleaning mechanism
32 hard outer shell
34 heat sink roller
36 input tube
38 output tube
40 radiator
42 fan
44 reservoir
46 cap

1. A mechanism for controlling temperature transients in a heated fuser roller of a reproduction apparatus comprising:
a heat sink roller movable between a first position and a second position, said first position being separated from said fuser roller and said second position being in contact with said fuser roller; and
a coolant inside said heat sink roller, said coolant selected to provide a contact heat load on said fuser roller when said heat sink roller is in contact with said fuser roller, said contact heat load being similar to a receiver member heat load on said fuser roller that would otherwise occur when a receiver member is passed through said fuser roller and an image is fused thereupon.

2. The mechanism according to claim 1, wherein said coolant is water.

3. The mechanism according to claim 1, further comprising:
an input tube for flowing said coolant into said heat sink roller; and
an output tube for flowing said coolant out from said heat sink roller.

4. The mechanism according to claim 3, wherein:
said coolant is virgin water from a water supply;
said virgin water is fed to said heat sink roller through said input tube; and
said virgin water passes through said heat sink roller and passes through said output tube to a wastewater drain.

5. The mechanism according to claim 3, further comprising:
a radiator connected to said input tube at a first end and connected to said output tube at a second opposite end, wherein said coolant flows through said radiator, into said heat sink roller via said input tube, through said heat sink roller, and back to said radiator via said output tube.

6. The mechanism according to claim 5, further comprising a fan for blowing air onto said radiator to thermally cool said coolant inside said radiator.

7. The mechanism according to claim 3, further comprising a reservoir connected to said input tube at a first end and connected to said output tube at a second opposite end, wherein said coolant flows through said reservoir, into said heat sink roller via said input tube, through said heat sink roller, and back to said reservoir via said output tube.

8. A mechanism for controlling temperature transients in a heated fuser roller of a reproduction apparatus comprising:
a heat sink roller movable between a first position and a second position, said first position being separated from said fuser roller and said second position being in contact with said fuser roller;
a coolant inside said heat sink roller, said coolant selected to provide a contact heat load on said fuser roller when said heat sink roller is in contact with said fuser roller, said contact heat load being similar to a receiver member heat load on said fuser roller that would otherwise occur when a receiver member is passed through said fuser roller and an image is fused thereupon;
an input tube for flowing said coolant into said heat sink roller; and
an output tube for flowing said coolant out from said heat sink roller;
wherein said coolant is virgin water from a water supply;
said virgin water is fed to said heat sink roller through said input tube; and
said virgin water passes through said heat sink roller and passes through said output tube to a wastewater drain.

9. The mechanism for controlling temperature transients in a heated fuser roller of a reproduction apparatus according to claim 8, wherein said water supply is tap water.

10. A fuser, for a reproduction apparatus, for permanently fixing a marking particle image to a receiver member, said fuser comprising:
a heated fuser roller operating at a setpoint temperature;
a heat sink roller movable between a first position and a second position, said first position being separated from said fuser roller and said second position being in contact with said fuser roller; and
a coolant inside said heat sink roller, said coolant selected to provide a contact heat load on said fuser roller when said heat sink roller is in contact with said fuser roller, said contact heat load being similar to a receiver member heat load on said fuser roller that would otherwise occur when a receiver member is passed through said fuser roller and an image is fused thereupon.

11. The fuser according to claim 10, wherein said coolant is water.

12. The fuser according to claim 10, further comprising:
an input tube for flowing said coolant into said heat sink roller;
an output tube for flowing said coolant out from said heat sink roller;
wherein said coolant is virgin water from a water supply;
said virgin water is fed to said heat sink roller through said input tube; and
said virgin water passes through said heat sink roller and passes through said output tube to a wastewater drain.

13. The fuser according to claim 10, further comprising:
an input tube for flowing said coolant into said heat sink roller;
an output tube for flowing said coolant out from said heat sink roller; and
a radiator connected to said input tube at a first end and connected to said output tube at a second opposite end, wherein said coolant flows through said radiator, into said heat sink roller via said input tube, through said heat sink roller, and back to said radiator via said output tube.

14. The fuser according to claim 13, further comprising a fan for blowing air onto said radiator to thermally cool said coolant inside said radiator.

15. The fuser according to claim 10, further comprising:
an input tube for flowing said coolant into said heat sink roller;
an output tube for flowing said coolant out from said heat sink roller; and
a reservoir connected to said input tube at a first end and connected to said output tube at a second opposite end, wherein said coolant flows through said reservoir, into said heat sink roller via said input tube, through said heat sink roller, and back to said reservoir via said output tube.

16. A reproduction apparatus for permanently fixing a marking particle image to a receiver member comprising:
a feeder belt for feeding a receiver member through said reproduction apparatus;
a receiver belt for receiving said receiver member having said marking particle image fused thereupon;
a heated fuser roller operating at a setpoint temperature;
a blanket fitting around an exterior of said fuser roller;
an oiler mechanism for applying an oil to said blanket, thereby preventing offsetting of said marking particle image to said fuser roller;
a cleaning mechanism for cleaning said blanket;
a heat sink roller movable between a first position and a second position, said first position being separated from said fuser roller and said second position being in contact with said fuser roller; and
a coolant inside said heat sink roller, said coolant selected to provide a contact heat load on said fuser roller when said heat sink roller is in contact with said fuser roller, said contact heat load being similar to a receiver member heat load on said fuser roller that would otherwise occur when said receiver member is passed through said fuser roller and an image is fused thereupon.

17. The reproduction apparatus according to claim 16, wherein said coolant is water.

18. The reproduction apparatus according to claim 16, further comprising:
an input tube for flowing said coolant into said heat sink roller; and
an output tube for flowing said coolant out from said heat sink roller;
wherein said coolant is virgin water from a water supply;
said virgin water is fed to said heat sink roller through said input tube; and
said virgin water passes through said heat sink roller and passes through said output tube to a wastewater drain.

19. The reproduction apparatus according to claim 16, further comprising:
an input tube for flowing said coolant into said heat sink roller;
an output tube for flowing said coolant out from said heat sink roller; and
a radiator connected to said input tube at a first end and connected to said output tube at a second opposite end, wherein said coolant flows through said radiator, into said heat sink roller via said input tube, through said heat sink roller, and back to said radiator via said output tube.

20. The reproduction apparatus according to claim 19, further comprising a fan for blowing air onto said radiator to thermally cool said coolant inside said radiator.

21. The reproduction apparatus according to claim 16, further comprising:
an input tube for flowing said coolant into said heat sink roller;
an output tube for flowing said coolant out from said heat sink roller; and
a reservoir connected to said input tube at a first end and connected to said output tube at a second opposite end, wherein said coolant flows through said reservoir, into said heat sink roller via said input tube, through said heat sink roller, and back to said reservoir via said output tube.

22. A method for reducing thermal transients in a heated fuser roller, operating at a setpoint temperature wherein a heat sink roller, filled with a coolant, and movable between a first position and a second position, said first position being separated from said fuser roller and said second position being in contact with said fuser roller is provided, said method comprising:
moving said heat sink roller into said second position at the start of a copy run;
allowing said fuser roller to reach said setpoint temperature;
moving said heat sink roller to said first position; and
passing at least one receiver member through said fuser roller to fuse an image thereupon.

23. The method according to claim 22, further comprising moving said heat sink roller to said second position when a last receiver member passes through said fuser roller.

24. The method according to claim 22, further comprising selecting said coolant to provide a contact heat load on said fuser roller when said heat sink roller is in contact with said fuser roller, said contact heat load being similar to a receiver member heat load on said fuser roller that would otherwise occur when a receiver member is passed through said fuser roller and an image is fused thereupon.

25. The method according to claim 22, wherein said coolant is water.

26. The method according to claim 22, further comprising:
introducing said coolant to said heat sink roller via an input tube; and
removing said coolant out from said heat sink roller via an output tube;
wherein said coolant is virgin water from a water supply;
said virgin water is fed to said heat sink roller through said input tube; and
said virgin water passes through said heat sink roller and passes through said output tube to a wastewater drain.

27. The method according to claim 22, further comprising:
introducing said coolant to said heat sink roller via an input tube; and
removing said coolant out from said heat sink roller via an output tube;
connecting said input tube to a first end of a radiator;
connecting said output tube to a second opposite end of said radiator, wherein said coolant flows through said radiator, into said heat sink roller via said input tube, through said heat sink roller, and back to said radiator via said output tube.

28. The method according to claim 27, further comprising blowing air onto said radiator to thermally cool said coolant inside said radiator.

29. The method according to claim 22, further comprising:
introducing said coolant to said heat sink roller via an input tube;
removing said coolant out from said heat sink roller via an output tube;
connecting said input tube to a first end of a reservoir; and
connecting said output tube to a second opposite end of said reservoir, wherein said coolant flows through said reservoir, into said heat sink roller via said input tube, through said heat sink roller, and back to said reservoir via said output tube.
